(19) United States
(12) Patent Application Publication
(10) Pub. No.: US 2026/0051519 A1
(43) Pub. Date: Feb. 19, 2026

(54) FUEL CELL SYSTEM INCLUDING SPLIT AIR FLOW STREAMS TO FUEL CELL COLUMN AND ATO AND METHOD OF OPERATING THE SAME

(71) Applicant: Bloom Energy Corporation, San Jose, CA (US)

(72) Inventors: Jesse DOTY, Santa Maria, CA (US); David EDMONSTON, Soquel, CA (US); Ralion HERZOG, Sunnyvale, CA (US)

(21) Appl. No.: 19/244,410

(22) Filed: Jun. 20, 2025

Related U.S. Application Data
(60) Provisional application No. 63/684,501, filed on Aug. 19, 2024.

(51) Int. Cl. H01M 8/04082; H01M 8/04007; H01M 8/04014; H01M 8/04746

(52) U.S. Cl. CPC H01M 8/04201; H01M 8/04014; H01M 8/04074; H01M 8/04753; H01M 8/04761

(57) ABSTRACT

A method of operating a fuel cell system includes providing fuel to a fuel cell column located in a hotbox, providing a column air stream to the fuel cell column and a separate anode tail gas oxidizer (ATO) air stream to an ATO located in the hotbox, where the ATO air stream bypasses the fuel cell column, and providing an anode exhaust from the fuel cell column to the ATO.

### FIELD

Aspects of the present invention relate to fuel cell systems and methods, and more particularly, to fuel cell systems including split fuel cell column and anode tail gas oxidizer (ATO) air flow streams.

### BACKGROUND

Fuel cells, such as solid oxide fuel cells, are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as the solid oxide regenerative fuel cells, that also allow reversed operation, such that oxidized fuel can be reduced back to unoxidized fuel using electrical energy as an input.

### SUMMARY

According to various embodiments, a fuel cell system, comprises a hotbox comprising a column air inlet, an anode tail gas oxidizer (ATO) air inlet, and a system exhaust outlet; a fuel cell column located in the hotbox and comprising one or more stacks of fuel cells; an ATO located in the hotbox and configured to oxidize anode exhaust output from the fuel cell column; at least one air blower located outside of the hotbox and configured to generate a column air stream that is provided to the column air inlet and an ATO air stream that is provided to the ATO air inlet, the ATO air stream bypassing the fuel cell column; a column air pathway configured to fluidly connect the column air inlet to the fuel cell column; an ATO air pathway configured to fluidly connect the ATO air inlet to the ATO; and an exhaust pathway configured to fluidly connect an outlet of the fuel cell column and an outlet of the ATO to the system exhaust outlet.

According to various embodiments, a method of operating a fuel cell system comprises: providing fuel to a fuel cell column located in a hotbox, the fuel cell column comprising at least one stack of fuel cells; providing a column air stream to the fuel cell column and a separate anode tail gas oxidizer (ATO) air stream to an ATO located in the hotbox, wherein the ATO air stream bypasses the fuel cell column; and providing an anode exhaust from the fuel cell column to the ATO.

### BRIEF DESCRIPTION OF THE DRAWINGS

The accompanying drawings, which are incorporated herein and constitute part of this specification, illustrate example embodiments of the invention, together with the general description given above and the detailed description given below.

FIG. 1A is a perspective view of a solid oxide fuel cell (SOFC) stack, and FIG. 1B is a side cross-sectional view of a portion of the stack of FIG. 1A.

FIG. 2A is a schematic of a SOFC system 200, according to an embodiment of the present disclosure, FIG. 2B is a perspective view of the hotbox 100 of the system 200 of FIG. 2A, FIG. 2C is a cross-sectional view of the hotbox 100 of FIG. 2B, and FIG. 2D is a schematic of a SOFC system 200, according to an alternative embodiment of the present disclosure,

FIGS. 3A-3E comprise annotated and/or enlarged views of portions of FIG. 2C, showing air and exhaust flows through the system 200.

FIG. 4 is a flow diagram illustrating a method of using a fuel cell system, according to various embodiments of the present disclosure.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

In a high temperature fuel cell system, such as a solid oxide fuel cell (SOFC) system, an oxidizing flow is directed to the cathode (i.e., air) side of the fuel cell while a fuel flow is directed to the anode (i.e., fuel) side of the fuel cell. The oxidizing flow is typically air, while the fuel flow can be hydrogen (H₂) or a hydrocarbon fuel, such as methane, natural gas, propane (LPG), ethanol, or methanol, or another suitable fuel, such as ammonia. The fuel cell, operating at a typical temperature between 700° C. and 950° C., enables the transport of negatively charged oxygen ions from the cathode flow stream to the anode flow stream, where the oxygen ions combine with either free hydrogen or hydrogen in a hydrocarbon or ammonia molecule to form water vapor and optionally combine with carbon monoxide to form carbon dioxide. The excess electrons from the negatively charged ions are routed back to the cathode side of the fuel cell through an electrical circuit completed between anode and cathode, resulting in an electrical current flow through the circuit.

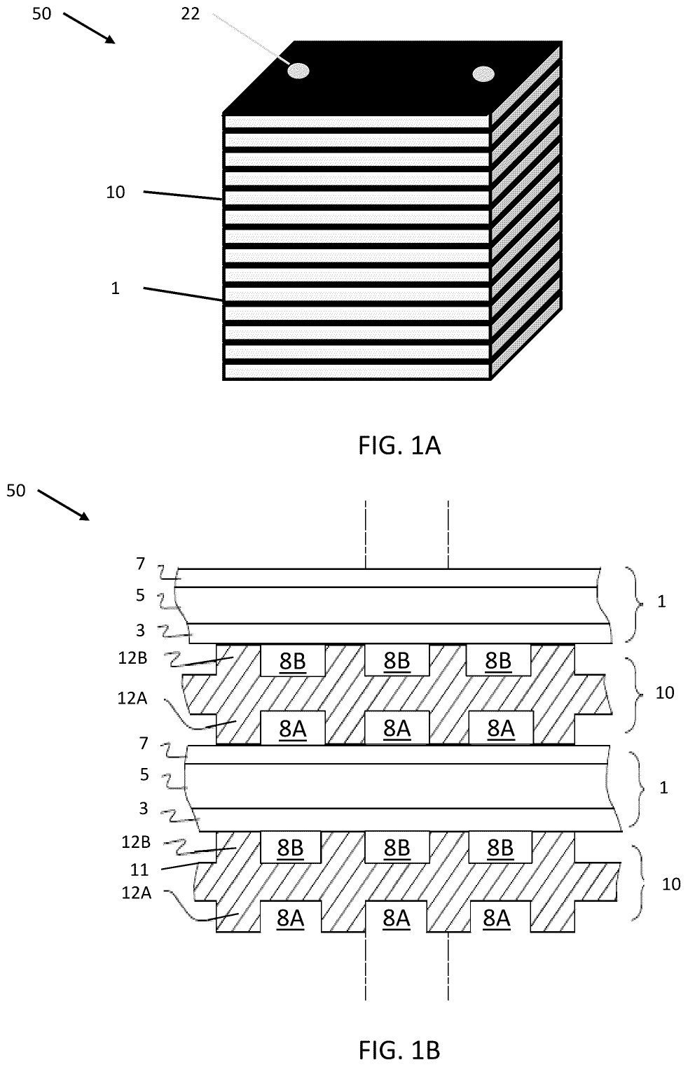

FIG. 1A is a perspective view of a fuel cell stack 50, and FIG. 1B is a side cross-sectional view of a portion of the stack 50 of FIG. 1A. Referring to FIGS. 1A and 1B, the stack 50 includes multiple fuel cells 1 that are separated by interconnects 10, which may also be referred to as gas flow separator plates or bipolar plates. The stack 50 also includes optional internal fuel riser channels 22.

In one embodiment, the fuel cells 1 may be solid oxide fuel cells. Accordingly, the stack 50 may be referred to as a solid oxide fuel cell (SOFC) stack 50. However, other types of fuel cells may be used in the stack. Multiple fuel cell stacks 50 may be arranged in a fuel cell column when stacked on top of each other. However, a fuel cell column may also refer to a fuel cell stack comprised of large number of SOFCs. Each solid oxide fuel cell 1 includes an air electrode (e.g., cathode) 3, a solid oxide electrolyte 5, and a fuel electrode (e.g., anode) 7. The air electrode 3 may comprise lanthanum strontium manganite (LSM) or other similar perovskite materials. The solid oxide electrolyte 5 may comprise a ceramic electrolyte, such as yttria stabilized zirconia (YSZ), scandia stabilized zirconia (SSZ), scandia and ceria stabilized zirconia or scandia, yttria and ceria stabilized zirconia. The fuel electrode 7 may comprise a nickel-YSZ, a nickel-SSZ or nickel-doped ceria cermet.

Each interconnect 10 electrically connects adjacent fuel cells 1 in the stack 50. In particular, an interconnect 10 may electrically connect the fuel electrode 7 of one fuel cell 1 to the air electrode 3 of an adjacent fuel cell 1. FIG. 1B shows that the lower fuel cell 1 is located between two interconnects 10. Each interconnect 10 includes fuel ribs 12A that at least partially define fuel channels 8A and air ribs 12B that at least partially define air channels 8B. The interconnect 10 may comprise a Cr—Fe alloy (e.g., 4-6 atomic percent iron and balance chromium) or a stainless steel interconnect. The interconnect 10 may operate as a gas-fuel separator that separates a fuel flowing to the fuel electrode 7 of one fuel cell 1 in the stack 50 from oxidant, such as air, flowing to the air electrode 3 of an adjacent fuel cell 1 in the stack 50. At either end of the stack 50, there may be an air end plate or fuel end plate (not shown) for providing air or fuel, respectively, to the end electrode. The air or fuel end plate may comprise an interconnect 10.

A fuel cell column may include one stack 50 or multiple stacks 50 arranged on one another. The column may be internally or externally manifolded for fuel and/or air. Optional anode splitter plates may be located between adjacent stacks 50 to provide fuel to the cells of each stack 50 as described in U.S. Pat. No. 10,511,047 B2, which is incorporated herein by reference in its entirety.

While a co-flow or counter-flow interconnect 10 is illustrated in FIG. 1B, in alternative embodiments, the interconnect 10 may comprise a crossflow interconnect in which the air and fuel channels extend perpendicular to each other, as described in U.S. Pat. No. 11,355,762 B2, which is incorporated herein by reference in its entirety. For example, such interconnects 10 may include two or more fuel holes per side of the interconnect.

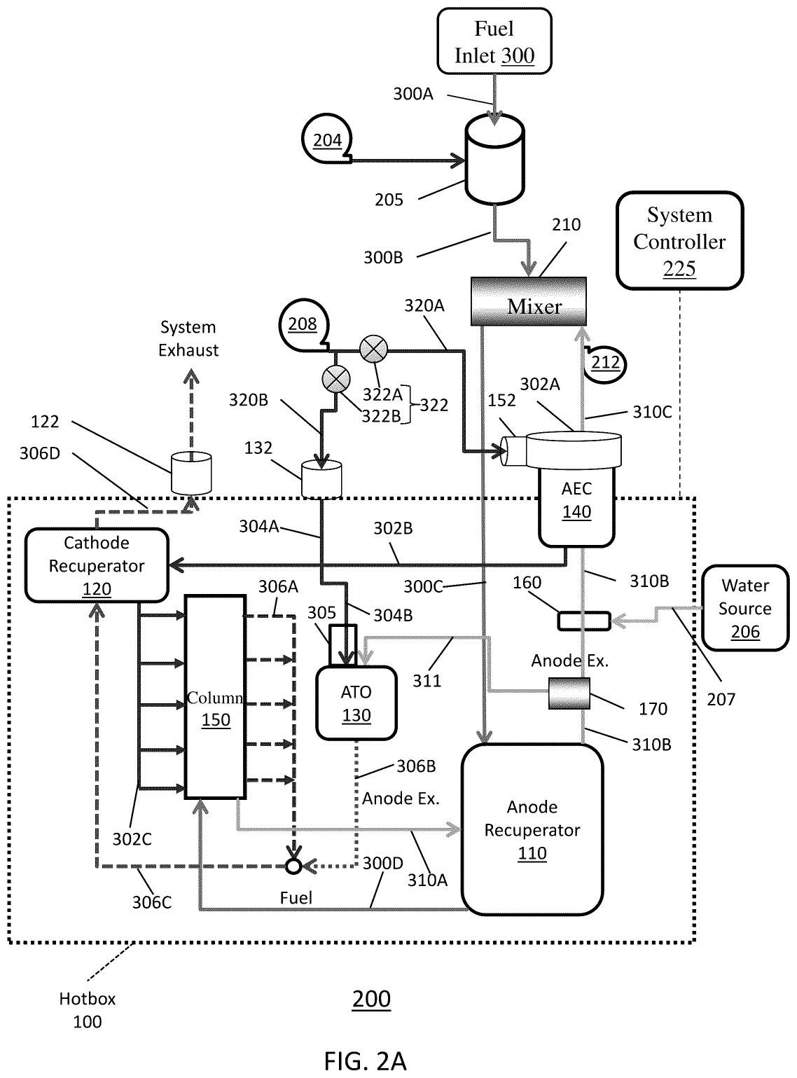

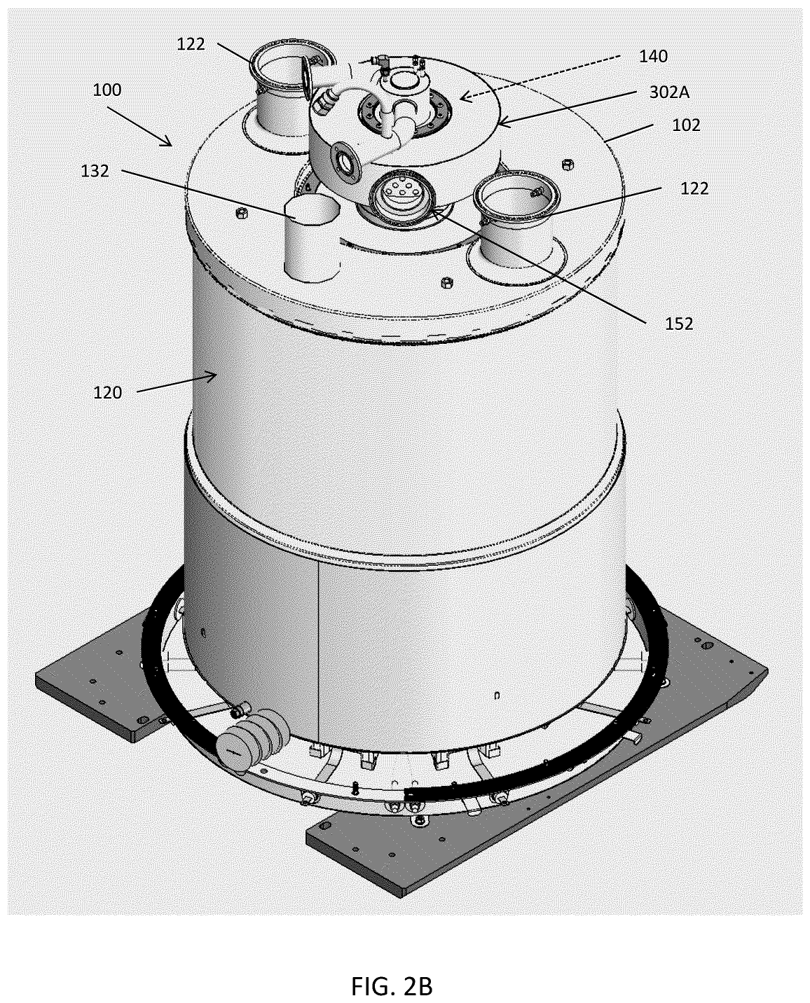

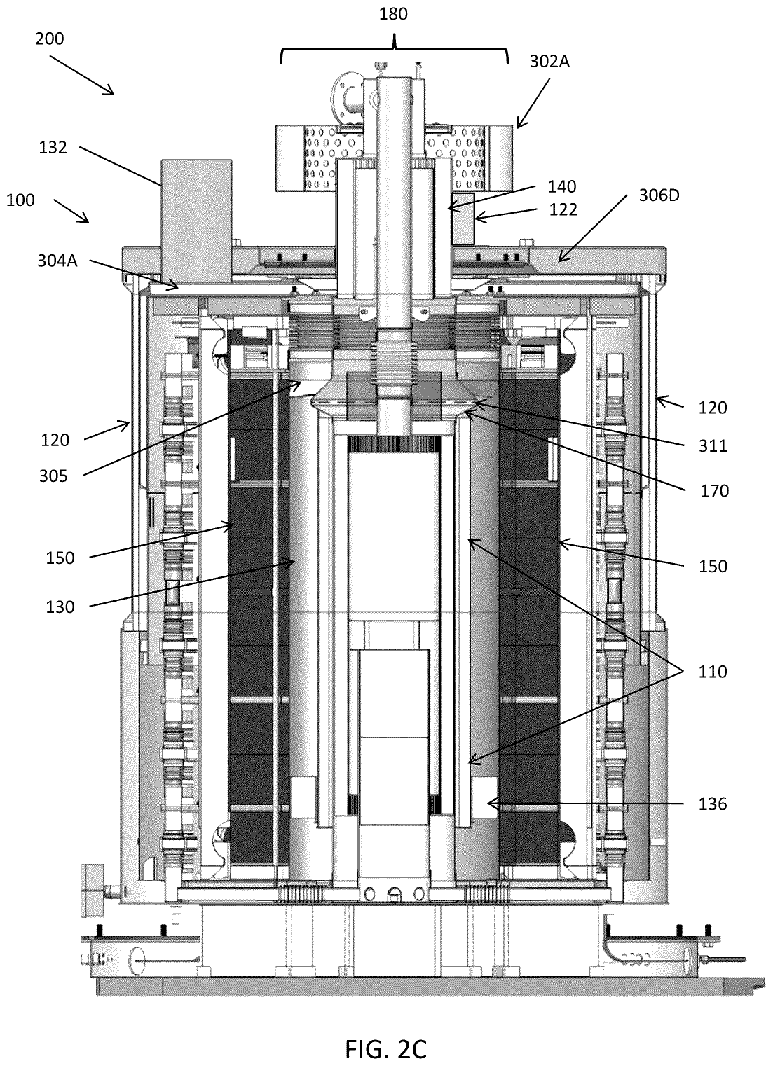

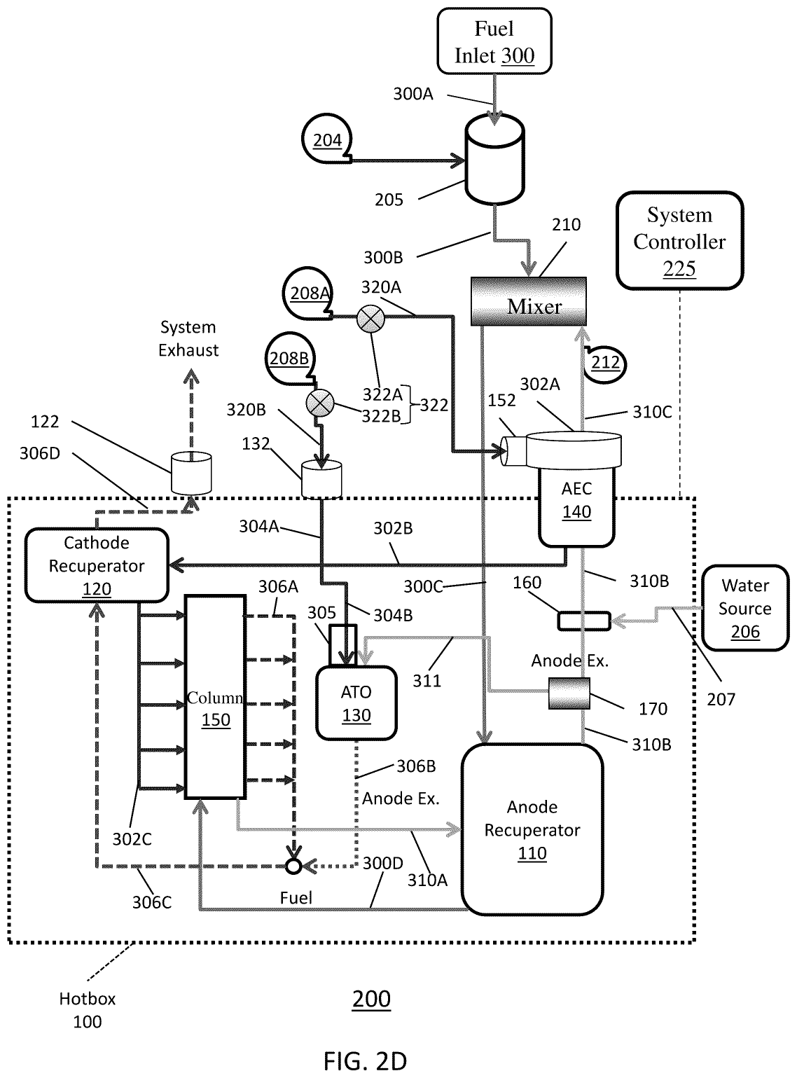

FIG. 2A is a schematic representation of a fuel cell system 200, according to a first embodiment of the present disclosure, FIG. 2B is a perspective view of the hotbox 100 of the system 200 of FIG. 2A, and FIG. 2C is a cross-sectional view of the hotbox 100 of FIG. 2B.

Referring to FIGS. 2A-2C, the system 200 includes a hotbox 100 and various components located therein or adjacent thereto. The hotbox 100 may contain at least one fuel cell column 150, which may include one or more fuel cell stacks, such as solid oxide cell stacks 50, as shown in FIGS. 1A and 1B.

The hotbox 100 may also contain an anode recuperator heat exchanger 110, a cathode recuperator heat exchanger 120, an anode tail gas oxidizer (ATO) 130, an anode exhaust cooler heat exchanger 140, an optional splitter 170, and a water injector 160. The system 200 may also include a catalytic partial oxidation (CPOx) reactor 205, a mixer 210, a CPOx blower 204 (e.g., air blower), a system blower 208 (e.g., main air blower), and an anode recycle blower 212, which may be located outside of the hotbox 100. However, the present disclosure is not limited to any particular location for each of the components with respect to the hotbox 100.

The CPOx reactor 205 receives a fuel inlet stream from a fuel inlet 300, through fuel conduit 300A. The fuel inlet 300 may be a fuel tank or a utility natural gas line including a valve to control an amount of fuel provided to the CPOx reactor 205. The CPOx blower 204 may provide air to the CPOx reactor 205 during system start-up. The fuel and/or air may be provided to the mixer 210 by fuel conduit 300B. Fuel flows from the mixer 210 to the anode recuperator 110 through fuel conduit 300C. The fuel is heated in the anode recuperator 110 by the fuel exhaust generated in the fuel cell column 150 and the fuel then flows from the anode recuperator 110 to the fuel cell column 150 through fuel conduit 300D.

An anode exhaust (e.g., fuel exhaust stream) generated in the fuel cell column 150 is provided to the anode recuperator 110 through an anode exhaust conduit 310A. The anode exhaust may contain unreacted fuel and may also be referred to herein as fuel exhaust. The anode exhaust may be provided from the anode recuperator 110 to the mixer 210 by anode exhaust conduits 310B, 310C. In particular, the anode exhaust conduit 310B may fluidly connect an outlet of the anode recuperator 110 to an inlet of the anode exhaust cooler 140. The anode exhaust conduit 310C may fluidly connect an outlet of the anode exhaust cooler 140 to an inlet of the mixer 210.

Water flows from a water source 206, such as a water tank or a water pipe, to the water injector 160 through a water conduit 207. The water injector 160 may be configured to inject water into anode exhaust flowing through the anode exhaust conduit 310B. The water injector 160 may be located upstream or downstream from optional splitter 170. Heat from the anode exhaust (also referred to as a recycled anode exhaust stream) vaporizes the water to generate steam which humidifies the anode exhaust. The humidified anode exhaust is provided to the anode exhaust cooler 140. Heat from the anode exhaust provided to the anode exhaust cooler 140 may be transferred to the air inlet stream provided from the system blower 208 to the cathode recuperator 120. The cooled humidified anode exhaust may then be provided from the anode exhaust cooler 140 to the mixer 210 via the anode exhaust conduit 310C. The anode recycle blower 212 may be configured to move the anode exhaust though the anode exhaust conduit 310C.

The mixer 210 is configured to mix the humidified anode exhaust with fresh fuel (i.e., fuel inlet stream). This humidified fuel mixture may then be heated in the anode recuperator 110 by the anode exhaust, before being provided to the fuel cell column 150. The system 200 may also include one or more fuel reforming catalysts located inside and/or downstream of the anode recuperator 110. The reforming catalyst(s) reform the humidified fuel mixture before it is provided to the fuel cell column 150. The splitter 170 may be operatively connected to the anode exhaust conduit 310B and to an anode exhaust diversion conduit 311. Thus, the splitter 170 is configured to divert a portion of the anode exhaust to the ATO 130 via the anode exhaust diversion conduit 311. In one embodiment, the anode exhaust diversion conduit 311 comprises one or more slits in the wall of the splitter 170, as shown in FIG. 2C.

The system 200 may include a central column 180 (see FIG. 2C) comprising the anode recuperator 110, the ATO 130, the anode exhaust cooler 140, the water injector 160, and the splitter 170. In particular, the anode exhaust cooler 140 may be located above the anode recuperator 110 and may extend through a cover 102 of the hotbox 100. The splitter 170 may be located between the anode recuperator 110 and the anode exhaust cooler 140, and the ATO 130 may at least partially surround the anode recuperator 110. The fuel cell columns 150 may be arranged around the central column 180, and the cathode recuperator 120 may at least partially surround the fuel cell columns 150. The ATO 130 may include an oxidation catalyst 136, such as a precious metal catalyst located on a catalyst support.

The system 200 may further include a system controller 225 configured to control various elements of the system 200. The system controller 225 may include a central processing unit configured to execute stored instructions. For example, the system controller 225 may be configured to control fuel and/or air flow through the system 200 by controlling the blowers 204, 208 and 212, fuel inlet valve(s) in the fuel source 300, and/or air valve(s) 322A, 322B described below, according to fuel composition data, temperature data, electrical data, or the like.

The present inventors have determined that operating SOFC columns at lower temperature decreases the degradation rate of the SOFCs and extends the column operating lifespans. However, in prior SOFC systems, the air exhaust from the SOFC columns is provided to the ATO along with recycled anode exhaust, in order to oxidize the anode exhaust. As such, prior SOFC systems were operated at higher than desired temperatures to maintain a sufficiently high column air exhaust temperature, in order to avoid decreasing the operating temperature of the ATO. Lower ATO operating temperatures can reduce oxidation rates, which may increase system emissions. Therefore, the prior art systems suffered from premature SOFC degradation and aging by operating at higher temperatures.

Various embodiments of the present disclosure provide systems and methods of operating fuel cell columns at a lower temperature without increasing system emissions, by providing split (i.e., separate) air flow streams to the fuel cell columns and to the ATO. Thus, a higher air flow may be provided to the fuel cell columns than in the prior art to reduce the fuel cell column operating temperature and decrease fuel cell degradation over time. In contrast, a lower air flow than in the prior art may be provided to the ATO to increase the ATO operating temperature and to increase the anode exhaust oxidation rate, which further reduces system emissions.

In particular, the system 200 may include air inlet conduits 320A, 320B configured to provide air to the hotbox 100 from the system blower (i.e., main air blower) 208, and at least one air valve 322 configured to control air mass flow rates through the air inlet conduits 320A, 320B. The system 200 may also include one or more system exhaust outlets 122, an ATO air inlet 132, and a column air inlet 152 that extend from a cover 102 of the hotbox 100. The first air inlet conduit 320A may be fluidly connected to the column air inlet 152, and the second air inlet conduit 320B may be fluidly connected to the ATO air inlet 132.

The system 200 may also include a column air pathway including first, second, and third column air conduits 302A, 302B, and 302C, an ATO air pathway including first and second ATO air conduits 304A and 304B, and an exhaust pathway including first, second, third, and fourth exhaust conduits 306A, 306B, 306C, 306D. The column air pathway may provide fluid connections for air to flow from the column air inlet 152 to the anode exhaust cooler 140 and to the fuel cell columns 150. In particular, the first column air conduit 302A may fluidly connect the column air inlet 152 to an inlet of the anode exhaust cooler 140, the second column air conduit 302B may fluidly connect an outlet of the anode exhaust cooler 140 to an inlet of the cathode recuperator 120, and the third column air conduit 302C may fluidly connect an outlet of the cathode recuperator 120 to air inlets of the fuel cell columns 150.

The ATO air pathway may provide fluid connections for air to flow from the ATO air inlet 132 to the ATO 130. In particular, the first ATO air conduit 304A may extend horizontally from the ATO air inlet 132 and may surround the bottom of the anode exhaust cooler 140. The second ATO air conduit 304B may extend vertically downward from the first ATO air conduit 304A to fluidly connect with an inlet of the ATO 130. Optionally, a mixer 305 may be located between the outlet of the second ATO air conduit 304B and the inlet of the ATO 130. The mixer 305 may comprise a plurality of vertically slanted vanes which impart an angular rotational flow direction to the ATO air flow entering the ATO 130 for improved air mixing with the anode exhaust entering the ATO 130 from the anode exhaust diversion conduit 311 (e.g., slits of the splitter 170).

The first exhaust conduit 306A is configured to receive air exhaust from the one or more fuel cell columns 150. The second exhaust conduit 306B is configured to receive ATO exhaust from the ATO 130. The third exhaust conduit 306C fluidly connects the first and second exhaust conduits 306A, 306B to an inlet of the cathode recuperator 120. The fourth exhaust conduit 306D provides system exhaust (e.g., a combination of the air exhaust and the ATO exhaust) output from the cathode recuperator 120 to the exhaust outlets 122 (see FIG. 2B).

FIG. 2D illustrates an alternative embodiment of the system 200 in which the system blower 208 is replaced with two separate air blowers 208A, 208B. A column air blower 208A is fluidly connected to the first air inlet conduit 320A, while a separate ATO air blower 208B is fluidly connected to the second air inlet conduit 320B.

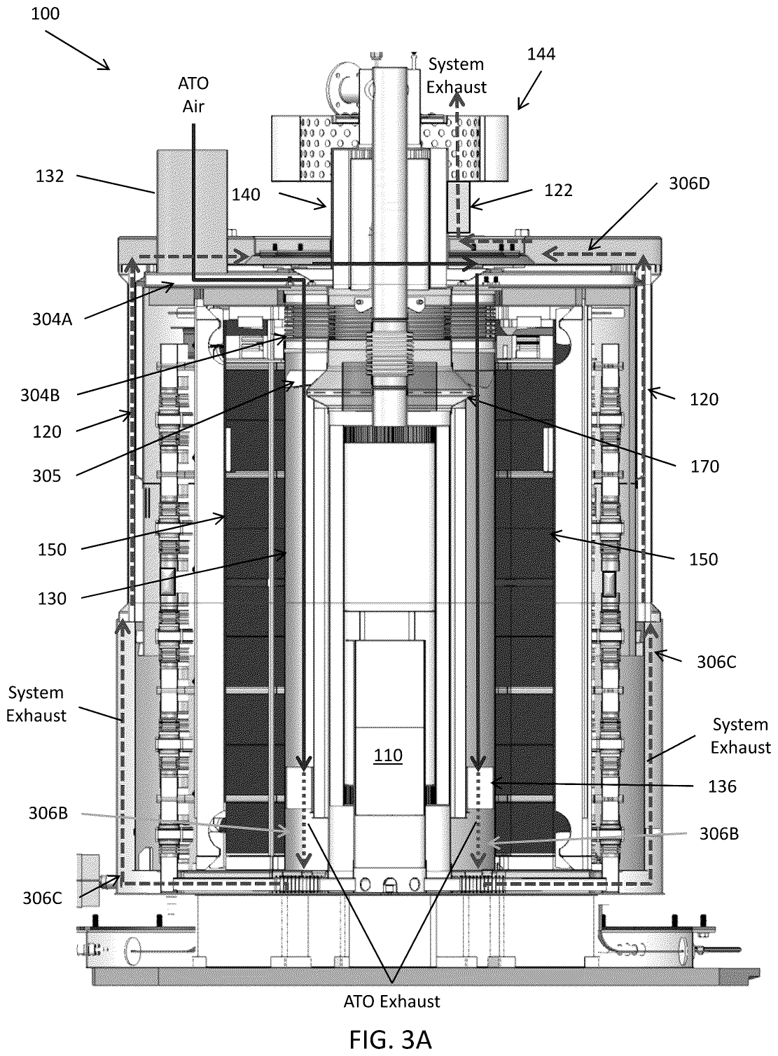

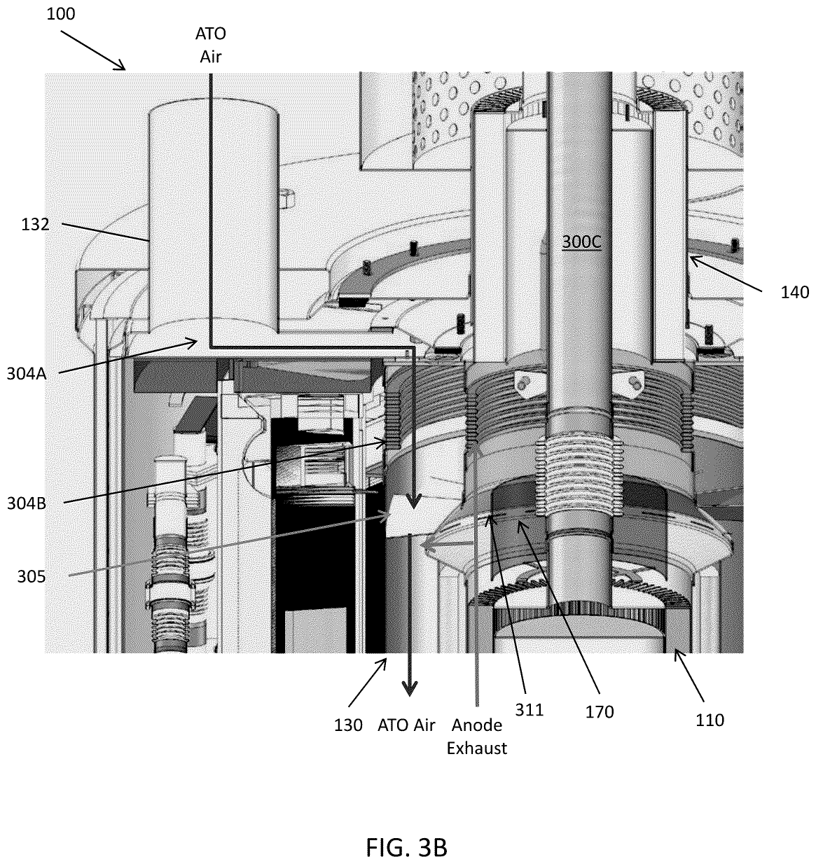

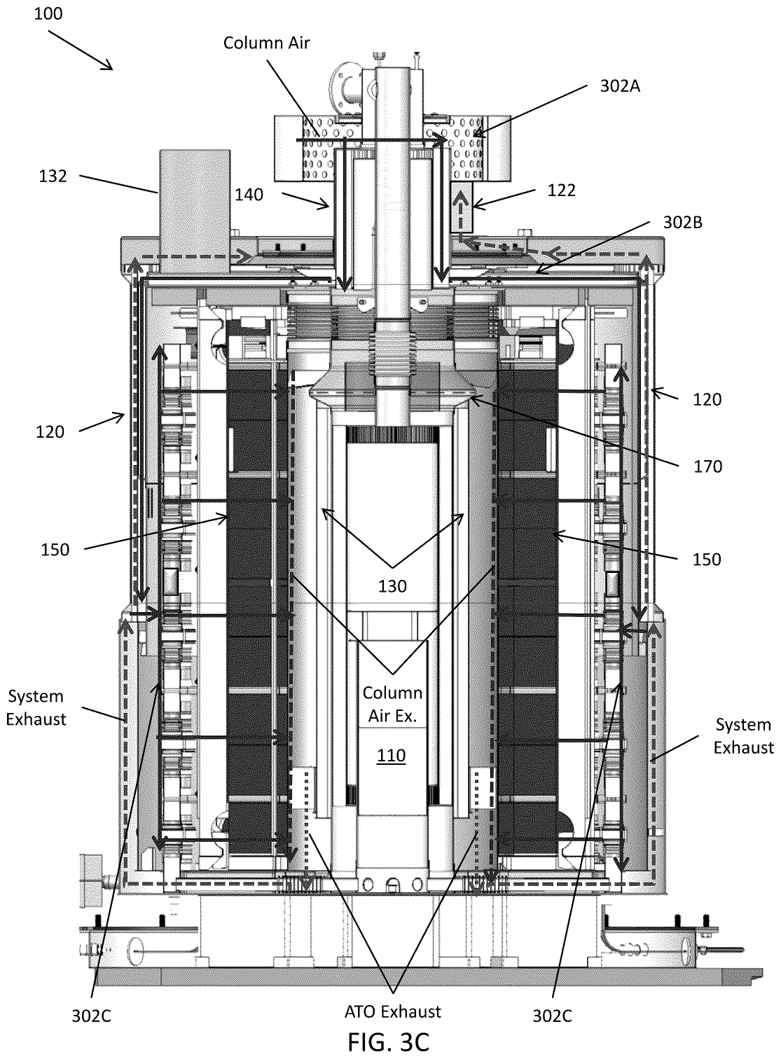

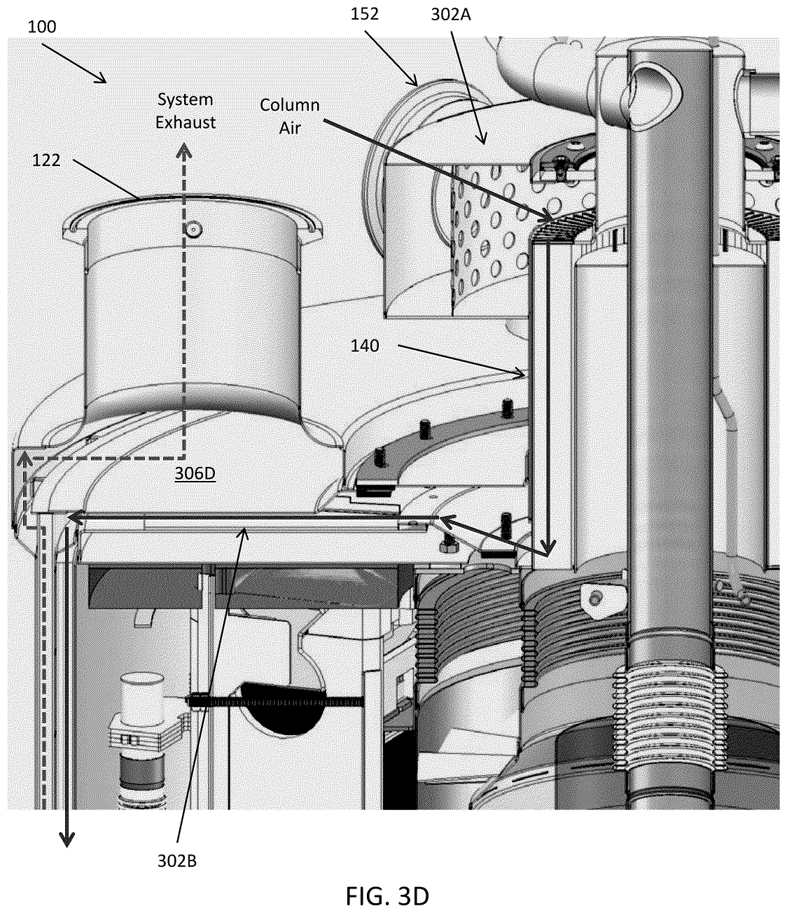

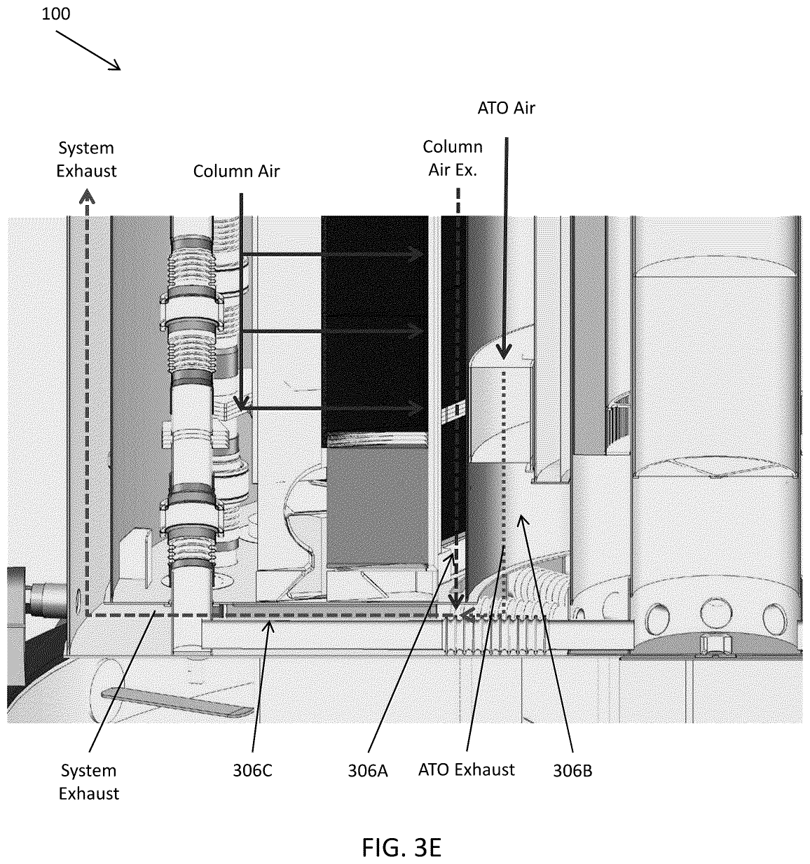

FIGS. 3A-3E comprise annotated and/or enlarged views of portions of FIG. 2C, showing air and exhaust flows through the system 200. Referring to FIGS. 2A, 2D, 3A and 3B, the system blower 208 or the ATO blower 208B may be configured to provide air (e.g., the ATO air stream) to the ATO air inlet 132 via the second inlet conduit 320B. The air is then distributed laterally by the first ATO air conduit 304A to the second ATO air conduit 304B. The air then flows vertically into an inlet of the ATO 130 through the optional mixer 305.

ATO exhaust is generated in the ATO 130 by oxidizing anode exhaust using the air provided by the second ATO air conduit 304B. The anode exhaust is provided to the ATO 130 from the splitter 170 through the anode exhaust diversion conduit 311, as shown in FIG. 3B. The ATO exhaust may be output through the second exhaust conduit 306B to the third exhaust conduit 306C, where the ATO exhaust is mixed with column air exhaust as discussed in detail below with respect to FIGS. 3C and 3E.

Referring to FIGS. 2A, 2D and 3C-3E, the system blower 208 or the column air blower 208A may be configured to provide air (e.g., the column air stream) to the column air inlet 152 via the first air inlet conduit 320A. The first column air conduit 302A distributes the air to the upper end of the anode exhaust cooler 140. The air flows through the anode exhaust cooler 140 and into the second column air conduit 302B, which distributes the air radially to the top of the cathode recuperator 120. The air flows down through the cathode recuperator 120 and is provided to the fuel cell columns 150 by the third column air conduit 302C. The air flows through the fuel cell columns 150 where it is converted into air exhaust (e.g., cathode exhaust).

The air exhaust flows through the first exhaust conduit 306A and is mixed with ATO exhaust provided from the second exhaust conduit 306B to form a mixture comprising the system exhaust in the third exhaust conduit 306C. The system exhaust flows laterally and then up through the third exhaust conduit 306C to the cathode recuperator 120. The system exhaust exits the top of the cathode recuperator 120 and is collected by the fourth exhaust conduit 306D, before flowing out of the hotbox 100 through the exhaust outlets 122.

Accordingly, as shown in FIGS. 2A and 3A-3E, the system 200 is configured to generate separate ATO and column air streams, which are respectively provided to the ATO and the fuel cell columns 150. The air exhaust stream output from the fuel cell columns 150 and the ATO exhaust stream output from the ATO 130 are combined into a system exhaust stream, which may be exhausted from the hotbox 100.

The system controller 225 may control the air valve(s) 322, in order to independently control the mass flow rates of the ATO air stream and the column air stream. In one embodiment, the air valve(s) 322 include a first air valve 322A located on the first air inlet conduit 320A and a second air valve 322B located on the second air inlet conduit 320B. In an alternative embodiment, a single multi-way (e.g., three-way) valve 322 may be located at the outlet of the system blower 208 to control the amount of air (e.g., air flow rate) provided into each of the first and second air inlet conduits 320A and 320B that are fluidly connected to the multi-way valve 322.

In another alternative embodiment shown in FIG. 2D, the system blower 208 is replaced with the two separate air blowers 208A, 208B. The column air blower 208A provides air to the first air inlet conduit 320A, while the separate ATO air blower 208B provides air to the second air inlet conduit 320B. Thus, the fuel cell column 150 and the ATO 130 are provided air from separate, independently controllable air blowers. In this alternative embodiment, the air valve(s) 322 (e.g., 322A and 322B) may be present or omitted.

The system controller 225 may control the air valve(s) 322 and/or air blower(s) 208 or (208A and 208B) based on desired operating temperatures of the cell columns 150 and the ATO 130. As such, the air mass flow through the fuel cell columns 150 may be increased, to reduce the operating temperature of the fuel cell columns 150, without a corresponding increase in the air mass flow rate to the ATO 130. In one embodiment, the air flow rate to the fuel cell columns 150 is higher than the air flow rate provided to the ATO 130.

As such, the operating temperature of the fuel cell columns 150 may be reduced by increasing air mass flow through the fuel cell columns 150, without reducing the operating temperature of the ATO 130. As a result, the lifespan of the fuel cells of the fuel cell columns 150 may be increased without increasing system emissions. Accordingly, embodiments of the present disclosure provide various unexpected benefits. For example, column air mass flow rates can be set to increase cell life cycles, without increasing the air flow to the ATO. As such, the ATO 130 may be operated at a higher temperature (e.g., a higher temperature than the fuel cell columns 150), which leads to reduced system 200 emissions. In addition, the ATO may utilize more restrictive (higher cells per square inch) catalysts with less pressure drop and less efficiency reduction, as the total air flow through the ATO catalyst is reduced using separate air streams.

In some embodiments, the ATO may include smaller steady-state catalysts that have a high precious metal content, thereby utilizing a lower total precious metal content, which also results in cost reduction. Various embodiments reduce overall cathode backpressure, as the ATO 130 may be provided with a relatively small volume of air, as compared to the larger volume of air provided to the fuel cell columns 150.

The ATO exhaust and the air exhaust are combined and provided to the cathode recuperator 120, such that heat energy can be recovered to heat the incoming column air stream. Airflow to the ATO 130 can be controlled to match other hotbox 100 conditions, such as the need to run different fuel utilization settings based on fuel cell health or gas compositions (e.g., blends of natural gas and hydrogen).

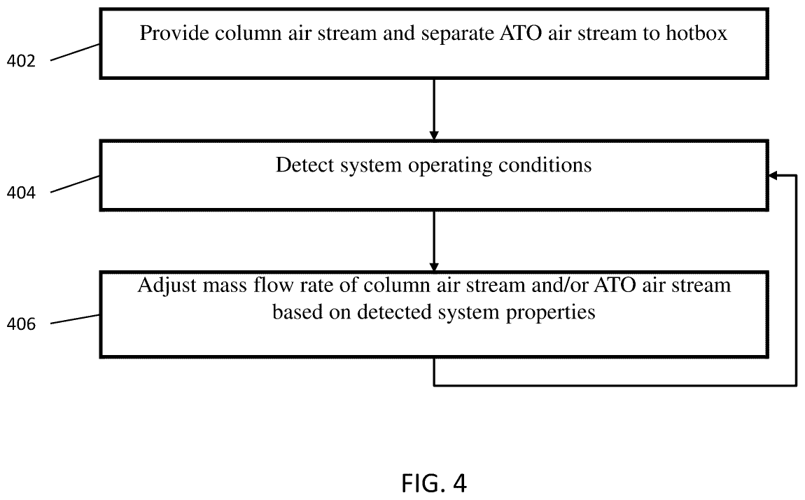

FIG. 4 is a flow chart illustrating steps of a method of operating a fuel cell system, according to various embodiments of the present disclosure. The method is described with respect to any suitable fuel cell system, which may include components as described with respect to the SOFC system 200 disclosed herein.

Referring to FIG. 2A-4, in step 402, the system 200 may be operated by providing fuel and air to the hotbox 100. In particular, fuel may be provided to the fuel cell columns 150 from the fuel inlet 300, air may be provided to the fuel cell columns 150 and the ATO 130 by the system blower 208, as shown in FIG. 2A or by the separate air blowers 208A and 208B, as shown in FIG. 2D. The system 200 may be initially operated in a startup mode were a relatively large amount of anode exhaust is diverted to the ATO 130 to generate heat until the system 200 reaches a desired steady-state operating temperature.

In step 404, the system controller 225 may detect the system 200 operating conditions. For example, the system controller 225 may detect the column 150 operating temperature, the ATO 130 operating temperatures, fuel utilization rates, fuel cell electrical resistance, or the like.

In step 406, the system controller 225 may independently adjust air mass flow rates to the fuel cell columns 150 and/or the ATO 130. For example, the system controller may control the air valve(s) 322 and/or speed of blower(s) 208 or (208A and/or 208B) to increase or decrease the air flow rate to the fuel cell columns 150, while maintaining the air flow rate to the ATO 130. Alternatively, the system controller may increase or decrease the air flow rate to the ATO 130, while maintaining the air mass flow rate to the fuel cell columns 150. Alternatively, the system controller may vary the air flow rate to both the fuel cell columns 150 and to the ATO 130 by the same or different amounts. The method may then return to step 404.

The column air stream is provided to all solid oxide fuel cell columns 150 located in the hotbox 100, and the ATO air stream bypasses all of the solid oxide fuel cell columns 150 located in the hotbox 100.

Fuel cell systems of the embodiments of the present disclosure are designed to reduce greenhouse gas emissions and have a positive impact on the climate.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A fuel cell system, comprising:
a hotbox comprising a column air inlet, an anode tail gas oxidizer (ATO) air inlet, and a system exhaust outlet;
a fuel cell column located in the hotbox and comprising one or more stacks of fuel cells;
an ATO located in the hotbox and configured to oxidize anode exhaust output from the fuel cell column;
at least one air blower located outside of the hotbox and configured to generate a column air stream that is provided to the column air inlet and an ATO air stream that is provided to the ATO air inlet, the ATO air stream bypassing the fuel cell column;
a column air pathway configured to fluidly connect the column air inlet to the fuel cell column;
an ATO air pathway configured to fluidly connect the ATO air inlet to the ATO; and
an exhaust pathway configured to fluidly connect an outlet of the fuel cell column and an outlet of the ATO to the system exhaust outlet.

2. The fuel cell system of claim 1, further comprising:
a first air inlet conduit fluidly connecting the at least one air blower to the column air inlet; and
a second air inlet conduit fluidly connecting the at least one air blower to the ATO air inlet.

3. The fuel cell system of claim 2, further comprising at least one air valve configured to control a flow rate of the column air stream through the first air inlet conduit and to control a flow rate of the ATO air stream through the second air inlet conduit.

4. The fuel cell system of claim 3, wherein the at least one air valve comprises a first air valve located in the first air inlet conduit and a second air valve located in the second air inlet conduit.

5. The fuel cell system of claim 3, wherein:
the at least one air blower comprises a single air blower; and
the at least one air valve comprises a first air valve located in the first air inlet conduit and a second air valve located in the second air inlet conduit.

6. The fuel cell system of claim 2, further comprising a system controller configured to control the at least one air valve or the at least one air blower, such that a flow rate of the column air stream is greater than a flow rate of the ATO air stream.

7. The fuel cell system of claim 6, wherein the column air stream is provided to multiple fuel cell columns located in the hotbox.

8. The fuel cell system of claim 2, wherein the at least one air blower comprises a column air blower fluidly connected to the first air inlet conduit, and an ATO air blower fluidly connected second air inlet conduit.

9. The fuel cell system of claim 1, further comprising:
an anode exhaust cooler heat exchanger configured to heat the column air stream using anode exhaust output from the fuel cell column; and
a cathode recuperator heat exchanger configured to heat the column air stream using a system exhaust stream comprising an ATO exhaust output from the ATO and a column air exhaust output from the fuel cell column.

10. The fuel cell system of claim 9, wherein the column air pathway comprises:
a first column air conduit that fluidly connects the column air inlet to an upper end of the anode exhaust cooler heat exchanger;
a second column air conduit that fluidly connects a lower end of the anode exhaust cooler heat exchanger to an upper end of the cathode recuperator heat exchanger; and
a third column air conduit that fluidly connects a lower end of the cathode recuperator heat exchanger to the fuel cell column,
wherein the column air pathway is configured to transfer the column air stream from the column air inlet to the anode exhaust cooler heat exchanger, from the anode exhaust cooler heat exchanger to the cathode recuperator heat exchanger, and from the cathode recuperator heat exchanger to the fuel cell column.

11. The fuel cell system of claim 10, wherein the ATO air pathway comprises:
a first ATO air conduit that is fluidly connected to the ATO air inlet and that surrounds a lower end of the anode exhaust cooler heat exchanger; and
a second ATO air conduit that fluidly connects the first ATO conduit to the ATO.

12. The fuel cell system of claim 11, wherein the exhaust pathway comprises:
a first exhaust conduit configured to receive the column air exhaust output from the fuel cell column;
a second exhaust conduit configured to receive the ATO exhaust output from the ATO;
a third exhaust conduit configured to fluidly connect the first and second exhaust conduits to the cathode recuperator heat exchanger; and
a fourth exhaust conduit configured to fluidly connect the cathode recuperator heat exchanger to the system exhaust outlet.

13. The fuel cell system of claim 1, wherein:
the column air inlet, the ATO air inlet, and the system exhaust outlet extend through a cover of the hotbox; and
the fuel cells comprise solid oxide fuel cells.

14. A method of operating a fuel cell system, comprising:
providing fuel to a fuel cell column located in a hotbox, the fuel cell column comprising at least one stack of fuel cells;
providing a column air stream to the fuel cell column and a separate anode tail gas oxidizer (ATO) air stream to an ATO located in the hotbox, wherein the ATO air stream bypasses the fuel cell column; and
providing an anode exhaust from the fuel cell column to the ATO.

15. The method of claim 14, further comprising independently adjusting a flow rate of the column air stream from a flow rate of the ATO air stream.

16. The method of claim 14, further comprising independently adjusting a flow rate of the ATO air stream from a flow rate of the column air stream.

17. The method of claim 14, wherein a flow rate of the column air stream is higher than a flow rate of the ATO air stream.

18. The method of claim 14, wherein the step of providing the column air stream and the ATO air stream comprises providing the column air stream and the ATO air stream from a single air blower located outside the hotbox though at least one air valve.

19. The method of claim 14, wherein the step of providing the column air stream and the ATO air stream comprises providing the column air stream from a column air blower located outside the hotbox, and providing the ATO air stream from a separate ATO air blower located outside the hotbox.

20. The method of claim 14, wherein the column air stream is provided to a plurality of solid oxide fuel cell columns located in the hotbox, and the ATO air stream bypasses the plurality of solid oxide fuel cell columns located in the hotbox.
